(19) United States
(12) Patent Application Publication
(10) Pub. No.: US 2016/0107166 A1
(43) Pub. Date: Apr. 21, 2016

(54) SELF CONTAINED COAL PROCESSING UNIT

(71) Applicant: IMPERIAL TECHNOLOGIES, INC., Canton, OH (US)

(72) Inventor: Ronald H. Tschantz, Malvern, OH (US)

(73) Assignee: IMPERIAL TECHNOLOGIES, INC.

(21) Appl. No.: 14/518,536

(22) Filed: Oct. 20, 2014

(51) Int. Cl. B02C 21/02; B02C 23/14

(52) U.S. Cl. CPC B02C 21/026; B02C 23/14

(57) ABSTRACT

A mobile coal processing unit can be loaded onto a truck and driven to an actual coal mine to break and sort coal. Once at the coal mine the mobile coal processing machine can self-propel itself to a desired location where it is to process coal. While at that location portions of the mobile coal processing machine that were folded and/or compressed for transportation are unfolded and/or uncompressed to make the mobile coal processing unit operational. The mobile coal processing unit includes a coal breaker to break mined coal into smaller pieces. It further includes a sorting device adapted to sort the smaller pieces and other mined coal into first size coal with a first size range and a second size coal with a second size range that is larger than the first size range.

### BACKGROUND OF THE INVENTION

1. Field of Invention

The current invention relates generally to apparatus, systems and devices for processing a variety of materials such as coal. More particularly, the apparatus, systems and devices relate to separating materials from rock. Specifically, the apparatus, systems and devices provide a mobile coal processing unit that separates different sized coal at a coal mining site.

2. Description of Related Art

It is often necessary upon removing coal from a mine or strip pit to further process the coal before it is used. This can be done by breaking the coal and sorting it into certain sizes and removing rocks, shale or other impurities therefrom. Depending upon the final use for which the coal is intended and the type and hardness of the particular coal being mined, the coal is broken and separated into predetermined size particles. Two inch sized particles are a common size for many burning applications.

This crushing and splitting of the coal has been performed by various types of equipment such as a rotary roll crusher in which coal passes between and is crushed by counter-rotating rolls and then discharged into a chute or conveyor for subsequent shipment. Such roll crushers have the disadvantage in that everything including coal and other impurities must go through the crusher rolls and everything is broken into smaller particles. It is preferable that impurities be removed, not crushed and transported with the coal. Another type of prior art crusher or breaker is a rotary breaker which consists of a large hollow rotating drum having a plurality of holes and baffles inside which will break the coal as it is tumbled within the drum.

Although these breakers perform satisfactorily, they require a considerable amount of energy for rotating the drum or crusher rolls. Furthermore, it is difficult to change the setting for the size of coal desired. Also, it is difficult to confirm the breaking force with the hardness of the particular seam of coal being broken by the equipment.

These known crushers usually are located at a coal wash plant which may be located some distance from the mine or pit, requiring the coal together with the impurities to be transported to the processing site with the refuse or removed impurities being returned to the original site for disposal. All of these hauling and processing operations increase the cost of processing the coal. What is needed is a better way of processing coal.

### SUMMARY

In one aspect, the invention may provide a mobile coal processing unit that can be connected to a truck and driven to an actual coal mining site to break and sort coal. This eliminates the need of trucking mined coal to a coal processing unit and the need of returning unwanted material back to the mine. Once at the coal mine the mobile coal processing machine can self-propel itself to a desired location where it is to process coal. While at that location portions of the mobile coal processing unit that were folded and/or compressed for transportation can be unfolded and/or uncompressed to make the mobile coal processing unit operational. The mobile coal processing unit includes a coal breaker to break mined coal into smaller pieces. It further includes a sorting device adapted to sort the smaller pieces and other mined coal into first sized coal with a first size range and a second sized coal with a second size range that is larger than the first size range.

In another aspect, the invention may provide a method of processing coal. The method begins by driving a truck hauling a mobile coal processing unit to a mine. Once at the mine, the mobile coal processing unit is separated from the truck. Because of its large size, portions of the mobile processing unit are at least partially folded or recessed into the mobile processing unit before being connected to the truck. Therefore, the method unfolds at least a portion of the mobile coal processing unit to make the mobile coal processing unit functional. Once functional, raw coal is received from the mine. The mobile coal processing unit is then operated to remove at least some stone and dirt from the raw coal.

### BRIEF DESCRIPTION OF SEVERAL VIEWS OF THE DRAWINGS

One or more example embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example mobile coal processing unit folded up and ready to be transported.

FIG. 2 is an enlarged perspective view of the example mobile coal processing unit of FIG. 1 offloaded from the truck and unfolded to an operation configuration.

FIG. 3 is a top view of the example mobile coal processing unit of FIG. 2.

FIG. 4 is a side view of the mobile coal processing unit in operation using a bypass conveyer.

FIG. 5 is a top view of the mobile coal processing unit of FIG. 4.

FIG. 6 is a side view of the mobile coal processing unit in operation showing how material is broken and sorted.

FIG. 7 is a top view of the mobile coal processing unit of FIG. 6.

FIG. 8 is a side view of the mobile coal processing unit in operation showing how some material is presorted and passes under the coal break unit.

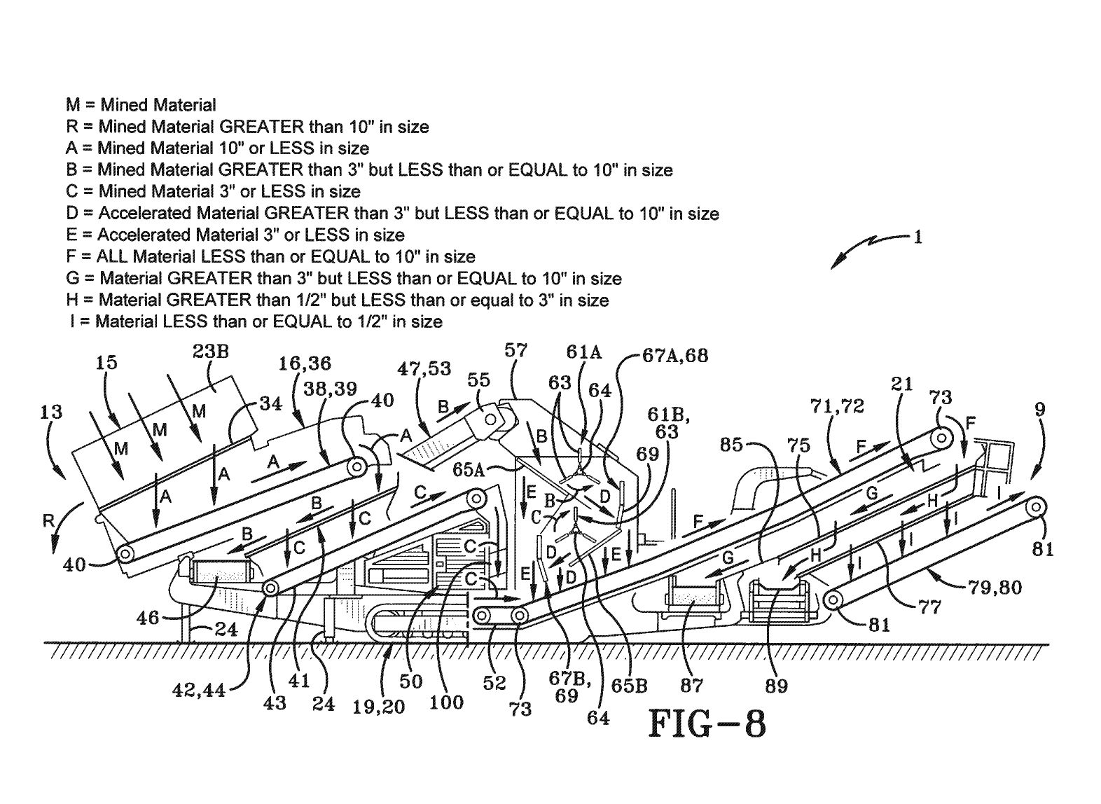

FIG. 9 is a top view of the mobile coal processing unit of FIG. 8.

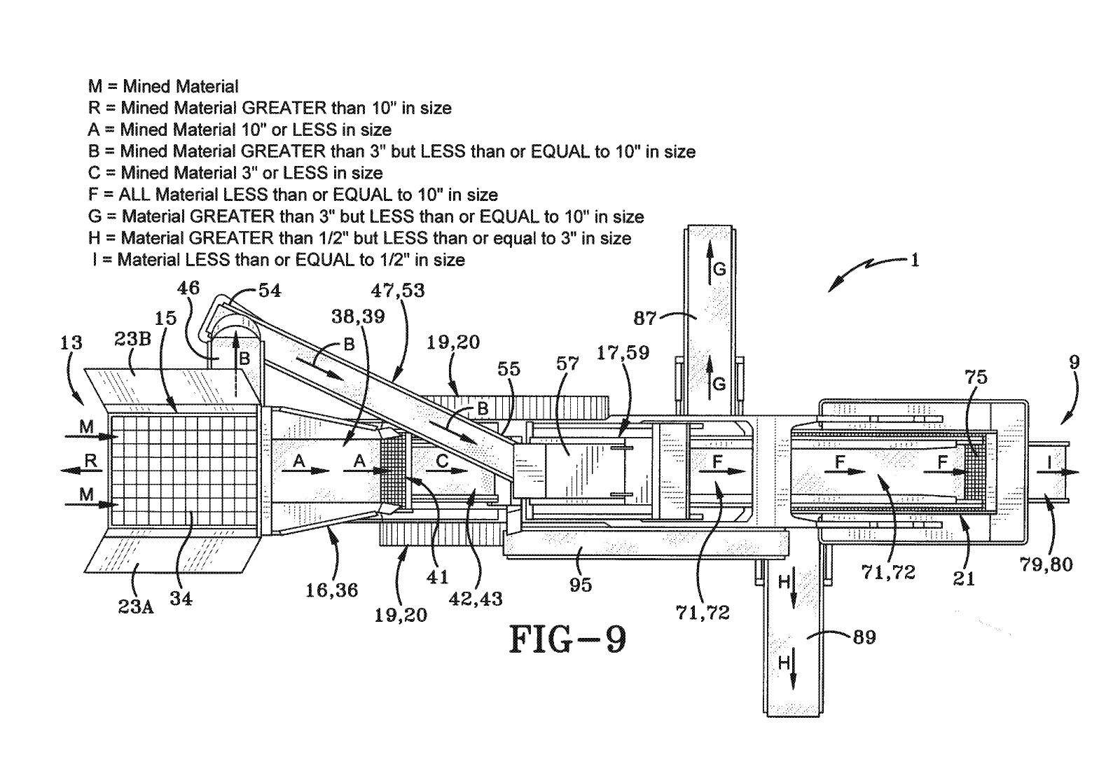

FIG. 10 illustrates the preferred embodiment configured as a method of using a mobile coal processing unit to break and sort coal.

Similar numbers refer to similar parts throughout the drawings.

### DETAILED DESCRIPTION

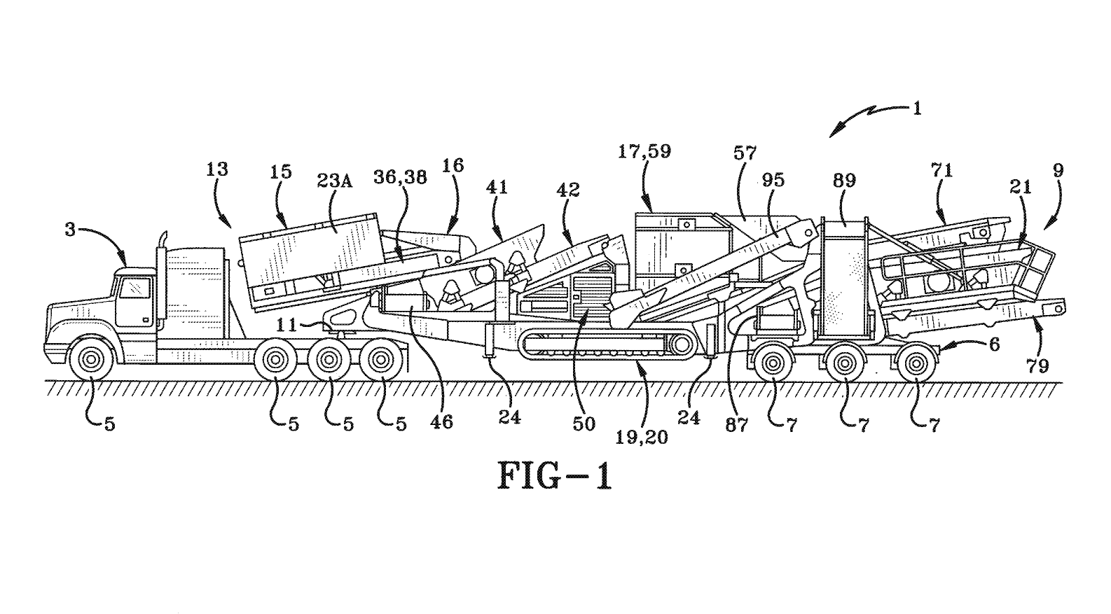

FIG. 1 illustrates an example embodiment of a mobile coal processing unit 1. The unit 1 is attached to a truck 3 with wheels 5. A wheel assembly 6 with additional wheels 7 is attached near a rear end 9 of the mobile coal processing unit 1. The unit 1 is attached to a fifth wheel 11 of the truck 3 near the front end 13 of the mobile coal processing unit 1. Some of the main components of the mobile coal processing unit 1 include: an intake hopper 15, a hopper conveyor assembly 16, a coal breaker 17 (e.g., accelerator), a propulsion unit 19, and a separation unit 21.

There are several benefits of the mobile coal processing unit 1 illustrated in the figures. First the unit can be driven to the actual mine itself and self-propelled on its own to the exact place it is to operate. Using it at the mine eliminates driving coal to the unit 1 from the mine and then bring unwanted products back to the mine and also eliminates the need to schedule all of that hauling. Thus, less material is handled which lowers product degradation. Additionally, higher quality coal leaves the mine.

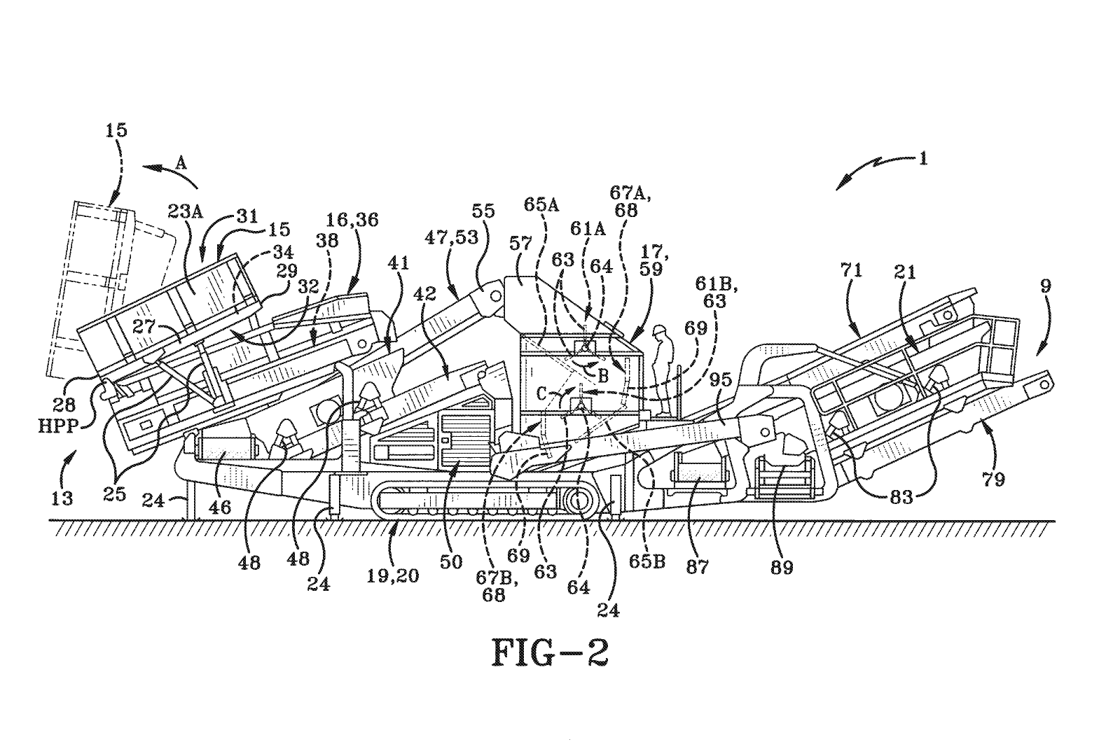

FIG. 2 illustrates the mobile coal processing unit 1 offloaded from the truck 3 and positioned at a processing site after it has been driven and propelled there with tracks 20, on its propulsion unit 19. Landing gear 24 can be lowered to support the unit 1 when it reaches where it is to operate. The landing gear 24 can be lowered using hydraulics or in another way, as understood by those of ordinary skill in the art.

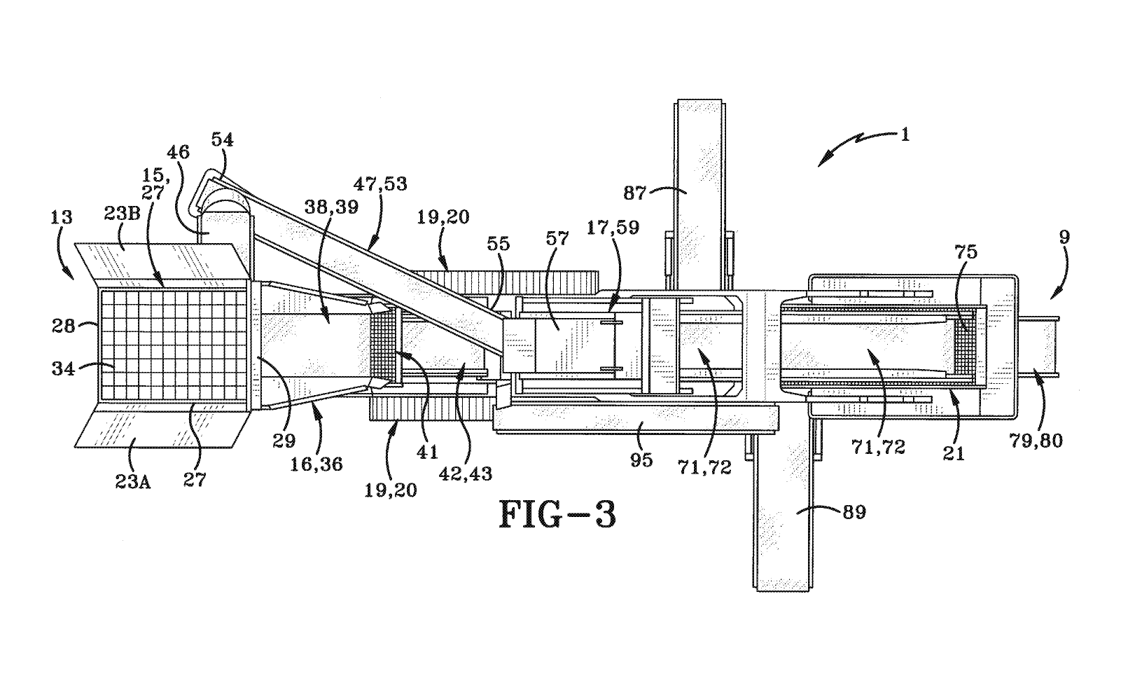

After the coal processing unit 1 is positioned, side walls 23A-B of the intake hopper 15 can be folded out as illustrated in FIGS. 2 and 3. Hydraulic actuators or other devices can be used to open and position these walls 23A-B. The intake hopper 15 has side walls 27, a front wall 28 and a back wall 29 that form a rectangular box with an open top and bottom. A hopper sorting grid 34 is located near the bottom 32 of the intake hopper 15. In the preferred embodiment, it has 10 inch by 10 inch square openings but it can have other sizes of opening depending the size of coal to be processed. The intake hopper 15 has a hopper pivot point (HPP) that allows the intake hopper 15 to tilt in the direction of arrow A.

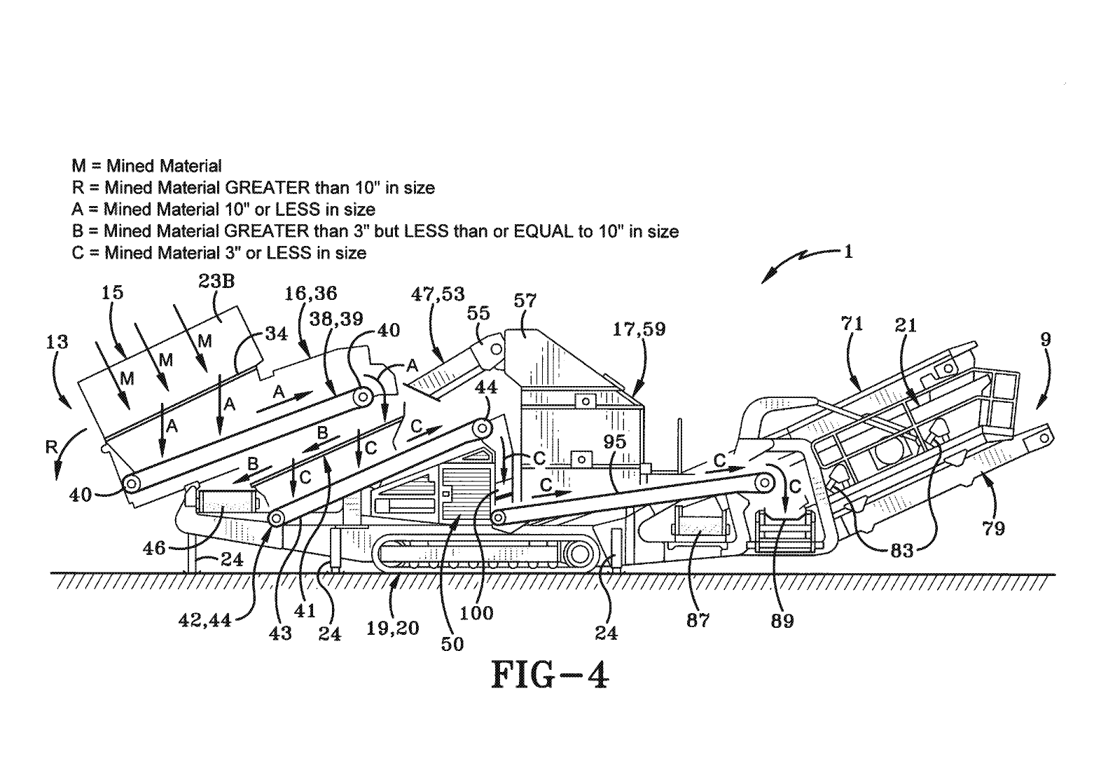

The hopper conveyor assembly 16 includes a housing 36 somewhat generally rectangular in shape and in the preferred embodiment is formed out of rigid metal or other materials. The housing 36 houses an intake conveyor 38 (best seen in FIG. 4) formed with a belt 39 and a pair of rollers 40 to rotate the belt 39. Preferably, the intake conveyor 38 is tilted upward from left to right as illustrated in FIG. 4. As understood by those of ordinary skill in the art, the intake conveyor 38 can be replaced with a drag chain or another device that can move the coal passing through the hopper grid 34.

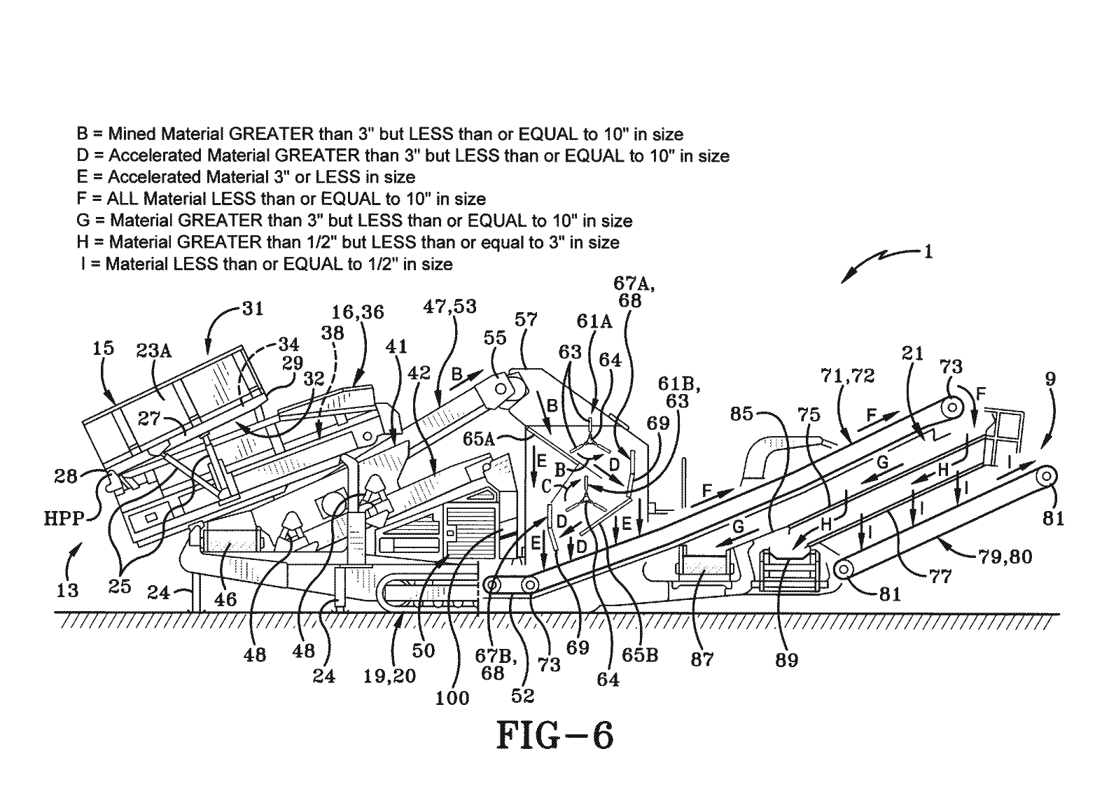

A first sorting device 41 is located under the intake conveyor 38 and above an initial screened material conveyor 42. The initial screened material conveyer 42 can be formed with a belt 43 wrapped around two rollers 44 as illustrated in FIG. 4. A pre-accelerator conveyor 52 is located under the initial screened material conveyer 42 (best seen in FIG. 6). The intake conveyor 38, initial screened material conveyor 42 and other conveyers discussed below can be formed with belts and rollers or they can be other types of devices that can move coal or similar materials as understood by one of ordinary skill in this art. The first sorting device has openings of between two inches and four inches to allow two inch to four inch sized coal to fall through the first sorting device. The openings can be other sizes depending on the desires of a user of the mobile coal processing unit 1.

In the preferred embodiment, the hopper conveyor assembly 16 can be mounted on spring mechanisms 48 (FIG. 2) or other suspension devices as understood by those of ordinary skill in the art. The spring mechanisms 48 allow the intake hopper 15 and the hopper conveyor assembly 16 to be agitated and/or shaken to facilitate coal material to pass through the hopper grid 34 and the first sorting device 41. This agitation and other hydraulic functions of the mobile coal processing unit 1 are, in the preferred embodiment, powered by a hydraulic engine 50 located in a housing under the initial screened material conveyor 42.

A first accelerator conveyor 46 is located under a front edge of the first sorting device 41. Of course this conveyor 46 can also include a belt wrapped around two rollers as understood by those of ordinary skill in this art. A second accelerator conveyor 47 is positioned with one end adjacent the first accelerator conveyor 46, as illustrated in FIGS. 2 and 3, and with a second end that is in a raised position at an input chute 57 on top of the coal breaker 17 (e.g., accelerator).

A rectangular accelerator housing 59 with opening at its top and bottom ends is positioned under the input chute 57. As best seen in FIG. 6, flail assemblies 61A-B are mounted interior to the housing 59. Each of the two flail assemblies 61A-B contain six paddles 63. The paddles 63 are arranged 120 degrees apart from each other with pairs of two paddles each adjacent each other. In the preferred embodiment, the paddles 63 are attached to a center shaft 64 using chains so that the paddles 63 will deflect when encountering large pieces of coal, dirt and/or rock. This prevents them from breaking. In operation, the paddles 63 are rotated in the direction of arrows B and C as illustrated in FIG. 2.

A pair of grizzlies 65A-B are located adjacent each of the flail assemblies 61A-B, respectively. The grizzlies 65A-B are similar to the grizzlies illustrated in U.S. Pat. No. 4,592,516 which is wholly incorporated herein by reference. Similar to this patent, the grizzlies 65A-B of FIG. 2 are formed with a parallel row of metal bars. However, the metal bars of these grizzlies 65A-B have tapered openings that get larger when moving from an upper end of a grizzly to a lower end of a grizzly so that larger material may pass through a grizzly's lower end than at its upper end. Additionally, the upper surface of each grizzly bar is curved and there is an inward tapered surface of each planer side wall of each grizzly bar so that both of each grizzly's two planer side walls are further apart where a side wall meets the curved upper surface than at the bottom ends of each of those side walls.

Impact grates 67A-B are located below and adjacent each of the grizzlies 65A-B, respectively. The impact grates 67A-B are grids that are formed with an array of openings that are about 1 inch by 1 inch to allow fine coal material (“fines”) to past through them. Of course, these opening can be other sizes depending on what size of fines is desired. In some configurations, one or more protruding pointed shapes (e.g., teeth) can be formed adjacent each opening to aid in the breaking/shattering of material being thrown against the impact grates 67A-B. As illustrated, each impact grate 67A-B can be formed with a first half 68 and a second halve 69 with an angle smaller than 180 degrees between them.

A pre-accelerator conveyor 52 is located near the front end and below the coal breaker 17 to transport coal from the initial screened material conveyor under the coal breaker 17. A post accelerator conveyor 71 has its first end located under the coal breaker 17 and its second end near an upper portion of the final separation unit 21 and its second end is near the front end of the mobile coal processing unit 1. Similar to previously mentioned conveyers, the pre-accelerator conveyor 52 and the post accelerator conveyor 71 can be formed with a belt 72 and a pair of rollers or it can be formed in other ways as appreciated by those of ordinary skill in this art.

The final separation unit 21 includes a second sorting device 75 located down-stream of the coal breaker and sorter 17. This sorting device 75 is in the preferred embodiment a grid with an array of openings of about three inches by three inches to allow material less than three inches to pass through. Of course, the openings can be other sizes as desired. A third sorting device 77 (FIG. 6) is located under the second sorting device 75. In the preferred embodiment, the third sorting device 77 is a grid of and array of openings and has openings of about ½ to 1 inch in size to allow fines material to pass through these openings.

A fines conveyor 79 is located under the second sorting device 75. Like previous conveyors, the fines conveyor 79 can include a belt 80 and a pair of rollers 81. Similar to the hopper conveyor assembly 16, the final separation unit 21 can include spring mechanisms 83 (FIG. 2) or other suspension devices as understood by those of ordinary skill in the art. The spring mechanisms 83 allow the second sorting device 75 and the third sorting device 77 to be agitated and/or shaken to facilitate coal material to pass through them.

A parallel slide ramp 85 extends from the second sorting device 75 as illustrated in FIG. 6. A large material conveyor 87 is located under a lower end of the slide ramp 85. A medium material conveyor 89 is located with one end under the third sorting device 77. The large material conveyor 87 as well as the medium material conveyor 89 can include a belt as well as two rollers as discussed above with reference to other conveyors.

Another novel feature of the mobile coal processing unit 1 is a path selection mechanism 100 (FIG. 4) located between the initial screened material conveyor 42 and the post accelerator conveyor 71. When the path selection mechanism 100 is in a first position as illustrated in FIG. 6, all material carried by the initial screened material conveyor 42 is dropped onto the post accelerator conveyor 71. However, when the path selection mechanism 100 is in a second position as illustrated in FIG. 4, all material carried by the initial screened material conveyor 42 is dropped onto a bypass conveyer 95 located between the initial screened material conveyor 42. The example path selection mechanism 100 is just one example of a path selection mechanism and that any mechanism as understood by one of ordinary skill in the art could be used to send coal/material from initial screened material conveyor 42 to the post accelerator conveyor 71 or the bypass conveyor 95.

Having described the physical characteristics of the components of the mobile coal processing unit 1, its use and operation are now described. Because the preferred embodiment of the mobile coal processing unit 1 is mobile it can be driven right to a job site where coal is being mined. It may be driven to a jobsite where other material is being processed to assist in the processing of the other material; however, simply for demonstration purposes, a coal processing site is discussed. Once at the job site (coal mine) the mobile coal processing unit 1 is detached from the truck 3 and the rear wheel assembly 6. Next, the mobile coal processing unit 1 is driven using its track assembly to the location where it is to process coal. Once there, its landing gear 24 is lowered and/or positioned to provide stable support for the mobile coal processing unit 1.

Coal to be processed is loaded into the top end of the intake hopper 15. For example a dump truck can back up to the intake hopper 15 and dump raw coal into the intake hopper 15 in the directions of arrows M as illustrated in FIG. 4. The hopper grid 34 will prevent any material that is larger than 10 inch by 10 from passing through the hopper grid 34 to intake conveyor 38. The material that is too large to pass through the hopper grid 34 will remain in the intake hopper 15. An operator can later, control a hydraulic mechanism to rotate the intake hopper 15 about the hopper pivot point HPP in the direction of arrow A (FIG. 2) so that the material that was too large to pass through the hopper grid 34 is removed from the intake hopper. This material can be further reduced in size before again being placed in the intake hopper 15 or it can be returned to the mine.

Coal that is 10 inch by 10 inch or smaller making it through the hopper grid 34 falls onto the intake conveyor 38 where it moves upwards and to the right before reaching the right end of the intake conveyor 38 and falling onto the first sorting device 41. Arrows A in FIG. 4 indicate these movements. The material next slides down the first sorting device 41 as indicated by arrows B in FIG. 4. The first sorting device 41 allows material of about three inches by three inches to drop through the first sorting device 41. As mentioned earlier, the first sorting device 41 can be sized differently to allow material of a different size to pass through it. As understood by those of ordinary skill in this art, an operator of the mobile coal sorting unit can activate a shaker/agitator device to cause the hopper grid 34 and first sorting device 41 to be shaking to facilitate moving more material through them. Coal larger than three inches in size does not pass through the first sorting device 41 and falls onto the first accelerator conveyor 46 where it will travel to the coal breaker 16 as discussed later.

Screening coal with the first sorter device 41 removes smaller material that does often does not need to enter the coal breaker 17. The only material that can be improved by the accelerator (coal breaker 17) is delivered to the accelerator and improves its process throughput capacity. This also increases the surface areas within the coal breaker 17 for improved impact breakage so that there is a reduction of cushioned surfaces with small material. Removing the small material also removes material that is wet and likely to plug up the coal breaker 17 and separation unit 21.

Material passing through the first sorting device 41 that is three inches or less in size falls onto initial screened material conveyor 42 traveling in the directions of arrows C as illustrated in FIG. 4. The initial screened material conveyor 42 moves this material upward and toward the coal breaker 17. Next, this material falls from the initial screened material conveyor 42 downward and will travel in one of two directions depending on whether the path selection mechanism 100 is in a first position or a second position. When the path selection mechanism 100 is in a first position, (FIG. 6) this coal will drop onto the pre-accelerator conveyor 52 and it is then transferred to the post accelerator conveyor 71. The post accelerator conveyor 71 transports this unsorted coal to sorting device(s) that will sort this coal as discussed below. If the path selection mechanism 100 is in a second position

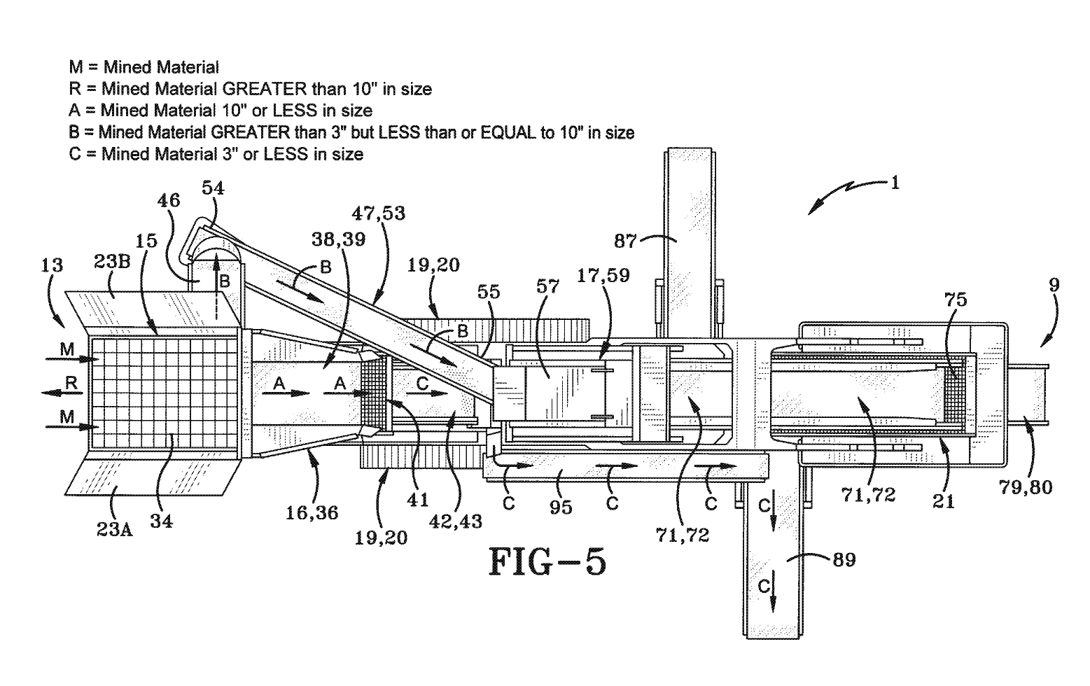

(FIG. 4), this coal will drop onto the bypass conveyor 91 where it further travels in the directions of arrows C (best seen in FIG. 5) until it drops onto the medium material conveyor 89 and proceeds towards its stockpile location. This bypassing of the coal breaker 16 provides for a way to generate more coal that is three inches and smaller when coal of this size is desired without generating additional fines.

Coal that is larger than three inches drops from the first sorting device 41 onto the first accelerator conveyor 46, as mentioned above. This material travels from the first accelerator conveyor 46 to the second accelerator conveyor 47 then upward on the second accelerator conveyor 47 toward the coal breaker 16 in the directions of arrow B as illustrated in FIG. 6. At the top end of the second accelerator conveyor 47 this coal drops into the input shoot 57 and begins it journey through the coal breaker 17.

Coal entering the coal breaker 17 initially falls onto the first grizzly assembly 65A where coal less than ½ an inch will pass/fall through the first grizzly assembly 65A and eventually fall onto post accelerator conveyor 71. Coal not passing through will slide down this grizzly 65A and be smacked by the first flail assembly 61A projecting it toward the first impact grate 67A. The accelerated coal will hit the impact grate 67A and shatter into smaller pieces with some pieces smaller than ½ of an inch passing through the impact grate 67A and falling onto post accelerator conveyor 71. Pieces not smaller than ½ of an inch fall onto the second grizzly 65B and any remaining material smaller than ½ of an inch fall through this grizzly 65B. Material not smaller than ½ of an inch slides down the second grizzly 65B wherein this material is smacked with the second flail 61B and projected toward the second impact grate 67B. This further shatters the coal and material smaller than ½ of an inch passes through the impact grate 67B and this and any remaining coal falls onto post accelerator conveyor 71.

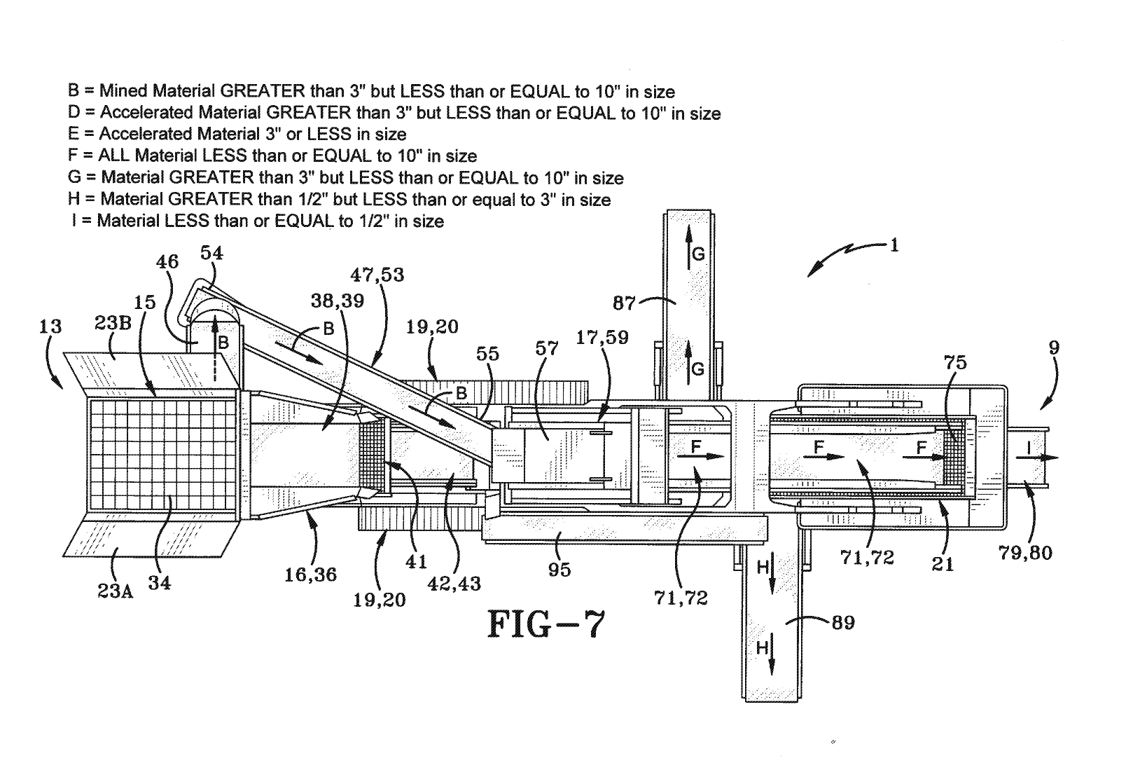

As mentioned above, where the path selection mechanism 100 is in its first position, coal from the initial screen conveyor 42 falls onto the pre-accelerator conveyer and is then transferred to the post accelerator conveyor 71. This coal and the broken coal from the coal breaker 16 are transported upward in the directions of arrows F as illustrated in FIG. 6. Upon reaching the upper end of the post accelerator conveyor 71, this material falls downward onto the second sorting device 75. Material smaller than three inches by three inches falls through the second sorting device 75 and material larger than this size slides off the second sorting device 75 and onto the large material conveyor 87 where it will be transported to a stock pile or loaded onto a truck in the direction of arrow G in FIG. 7. If this material contains a lot of rock and impurities it will be returned to the local mine by the truck or disposed of in other ways.

Material less than three inches passing through the second sorting device 75 will fall onto the third sorting device 77 that will allow material (fines) less than ½ inch by ½ inch to pass through it as illustrated by arrows I in FIG. 6. This fines material falls onto the fines conveyor 79 and begins its journey in the direction of arrow I (FIG. 7) to where it is used, stored and/or transported. Material less than three inches but smaller than ½ inch slides down the third sorter device 77 in the directions of arrows H (FIG. 6) and falls from the third sorting device 77 onto the medium material conveyor where it begins its journey in the direction of arrow H (FIG. 7) to where it is used, stored and/or transported.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

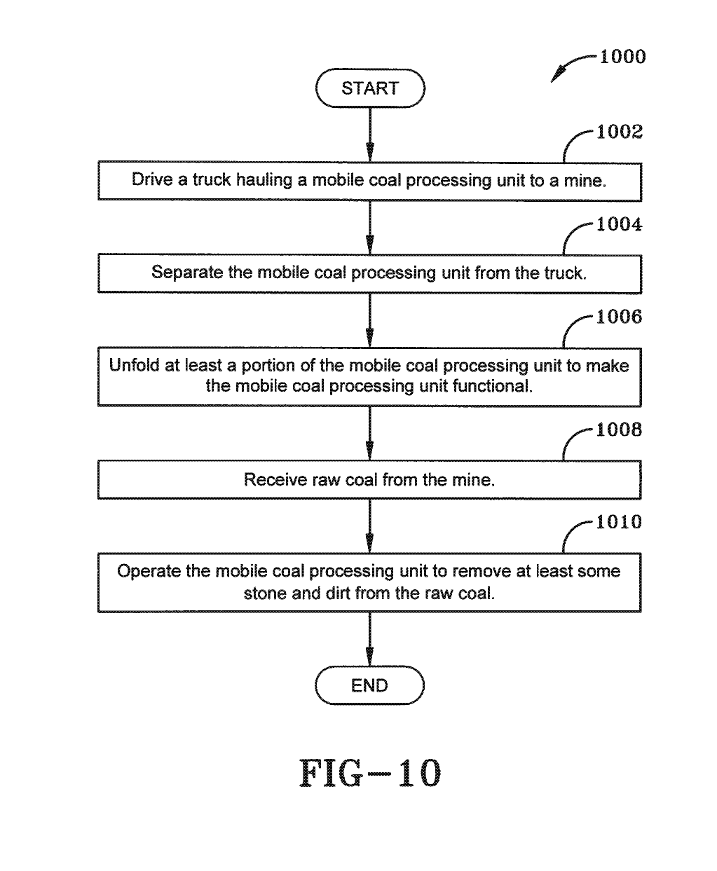

FIG. 10 illustrates a method 1000 of processing coal. The method 1000 begins, at 1002, by driving a truck hauling a mobile coal processing unit to a mine. Once at the mine, the mobile coal processing unit is separated, at 1004, from the truck. Because of its large size, portions of the mobile processing unit were at least partially folded or recessed into the mobile processing unit. Therefore, the method 1000 unfolds at least a portion of the mobile coal processing unit, at 1006, to make the mobile coal processing unit functional. Once functional, raw coal is received from the mine, at 1008. The mobile coal processing unit is then operated, at 1010, to remove at least some stone and dirt from the raw coal.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the example embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the example embodiment” or “in the example embodiment” does not necessarily refer to the same embodiment, though it may.

1. A mobile coal processing unit comprising:
a coal breaker adapted to break mined coal into processed coal;
a sorting device adapted to sort either the minded coal or the processed coal into first size coal with a first size range and a second size coal with a second size range that is larger than the first size range, wherein the mobile coal processing unit is adapted to be attached to a truck for transportation to a coal mining site where the mobile coal processing unit is disconnected from the truck and is adapted to be set up for operation.

2. The mobile coal processing unit of claim 1 and further comprising:
a path selection mechanism adapted to be placed in a first position and a second position, wherein when the path selection mechanism is in the first position the first size coal does not bypass the sorting device and when the path selection mechanism is in the second position the first size coal bypasses the sorting device.

3. The mobile coal processing unit of claim 2 wherein the sorting device is a first sorting device and further comprising:
a second sorting device adapted to separate the processed coal into first sorted coal with a third size range and a second sorted coal with a forth size range that is smaller than the third size range; and
a post accelerator conveyor passing under the coal breaker adapted to transport the processed coal to the second sorting device, wherein when the path selection mechanism is in the first position the second size coal drops onto the post accelerator conveyor and is combined with the processed coal created by the coal breaker.

4. The mobile coal processing unit of claim 3 wherein the path selection mechanism is pivotal to pivot between the first position and the second position.

5. The mobile coal processing unit of claim 3 wherein third size range is the same as the first size range, and wherein the fourth size range is the same as the second size range.

6. The mobile coal processing unit of claim 3 further comprising:
a third sorting device adapted to receive the second sorted coal and is adapted to separate the second sorted coal into a third sorted coal with a fifth size range that is smaller than the forth size range.

7. The mobile coal processing unit of claim 6 wherein the third size range is greater than 2 inches, wherein the forth size range is between 4 inches and ½ inch and wherein the fifth size range is less than 1 inch.

8. The mobile coal processing unit of claim 2 further comprising:
a bypass conveyor adapted to transport the second size coal without mixing the second size coal with the processed coal created by the coal breaker.

9. The mobile coal processing unit of claim 1 further comprising:
a movement device adapted to move the mobile coal processing unit across the ground after the mobile coal processing unit is disconnected from the truck.

10. The mobile coal processing unit of claim 1 further comprising:
an agitator configured to shake the sorting device.

11. A mobile coal processing unit comprising:
a coal breaker adapted to break mined coal into processed coal;
a sorting device adapted to sort either the mined coal or the processed coal into various sized coal;
a wheel assembly for movability supporting the coal breaker and sorting device; and
an attachment device for attaching the wheel assembly to a towing vehicle for transporting the coal breaker and sorter device to a coal mining site.

12. The mobile coal processing unit of claim 11 wherein the sorting device includes first and second sorters, said first sorter being located upstream of the coal breaker and the second sorter being located downstream of the coal breaker.

13. The mobile coal processing unit of claim 12 further comprising:
a path selection mechanism located between the first sorter and coal breaker and moveable between first and second positions, and wherein when the path selection mechanism is in the first position, coal passing through the first sorter does not bypass the coal breaker and when the path selection mechanism is in the second position said coal passing through the first sorter bypasses the coal breaker.

14. The mobile coal processing unit of claim 13 including:
a conveyor in communication with the coal breaker for transporting the processed coal from the coal breaker to the second sorter, and wherein when the path selection mechanism is in the second position the coal passing through the first sorter moves onto the conveyor and is combined with the processed coal created by the coal breaker.

15. The mobile coal processing unit of claim 12 wherein the sorting device further comprises a third sorter in communication with the second sorter for further separating the coal passing through the first sorter into various size coal.

16. The mobile coal processing unit of claim 12 wherein the first sorter further comprises:
a grid with an array of openings for letting coal of a predetermined size to pass through; and
a bypass conveyor adapted to transport the said predetermined size coal without mixing the said predetermined size coal with the processed coal created by the coal breaker.

17. A method of processing coal comprising:
driving a truck hauling a mobile coal processing unit to a mine;
separating the mobile coal processing unit from the truck;
unfolding a least a portion of the mobile coal processing unit to make the mobile coal processing unit functional;
receiving raw coal from the mine; and
operating the mobile coal processing unit to remove at least some stone from the raw coal.

18. The method of claim 17 further comprising the further steps of:
separating the raw coal into at least two streams of coal of different sizes;
breaking at least one of the streams of coal in a coal breaker; and
allowing the second stream of coal to bypass the coal breaker.

19. The method of claim 17 comprising the further steps of:
moving the coal processing unit along the ground to a desired location adjacent the mine after separating the coal processing unit from the truck.

20. The method of claim 17 further comprising:
removing rock from the raw coal; and
separating the raw coal into at least three streams of coal of different sizes.
